(19) United States
(12) Patent Application Publication
(10) Pub. No.: US 2008/0054084 A1
(43) Pub. Date: Mar. 6, 2008

(54) Two-wire power and communication link for a thermostat

(75) Inventor: John C. Olson, Shoreview, MN (US)

Correspondence Address: William O'Driscoll;12-1, Trane, 3600 Pammel Creek Road, La Crosse, WI, 54601, US

(73) Assignee: American Standard International Inc.

(21) Appl. No.: 11/512,632

(22) Filed: Aug. 29, 2006

(51) Int. Cl. G05D 23/12

(52) U.S. Cl. 236/1 C

(57) ABSTRACT

A single pair of polarity independent wires conveys electrical power and two-way communication between a remote thermostat and a temperature-conditioning unit. The system is functional even if the wires are crossed, so mis-wiring is nearly impossible. The system is selectively operable in three independently distinct modes: a power mode for conveying electrical power from the temperature-conditioning unit to the thermostat, an output mode for transmitting a communication signal from the temperature-conditioning unit to the thermostat, and a feedback mode for conveying a communication signal from the thermostat to the temperature-conditioning unit. When the power mode is inactive during the output mode and feedback mode, the thermostat relies on electrical power that the thermostat stored during a previous power mode. Communication is provided by a current loop circuit that is generally immune to electrical noise and tolerant of wire impedance.

### BACKGROUND OF THE INVENTION

1. Field of the Invention

The subject invention generally pertains to a controller for an HVAC system (heating ventilating and air conditioning system) and more specifically to a power and communication link for such a system.

2. Description of Related Art

Packaged Terminal Air Conditioners/Heat Pumps or PTACs, as they are known in the HVAC industry, are self-contained refrigerant systems often used for cooling and heating hotel rooms; however, they are also used in a variety of other commercial and residential applications such as apartments, hospitals, nursing homes, schools, and government buildings. PTACs are usually installed in an opening of a building's outer wall, so an exterior-facing refrigerant coil can exchange heat with the outside air.

In warmer climates, PTACs might only be used for cooling. In cooler climates, however, the refrigerant side of the system may be a heat pump for heating or cooling. PTACs may also include an electric heater if the refrigerant system lacks a heating mode or if the heat pump is unable to meet the heating demand of particularly cold days. PTAC's are also available with a hydronic (water/steam) heating option.

To control the temperature of a room, PTACs can be controlled in response to a temperature sensor that is usually installed in one of two locations. The temperature sensor can be installed within the PTAC's housing itself or in a thermostat mounted to a wall or some other remote location in the room. Both locations have their advantages and disadvantages.

Installing the sensor within the PTAC's housing is usually less expensive and simplifies the installation of the system. In such a location, however, the sensor may not necessarily provide the best temperature reading, as the temperature is being sensed at the elevation and vicinity of where the heating or cooling is occurring rather than at the location of the occupants in the room. Moreover, since PTACs are usually mounted along an outside wall and usually beneath a window, the temperature of the outside air and sunshine through the window can affect the sensor.

A wall-mounted sensor, on the other hand, can be spaced apart from the window, outside wall, and PTAC housing, and it can be installed closer to the occupants. Thus, a wall-mounted sensor may provide a reading that more accurately represents the room's overall temperature. In the case of a hotel installation, a wall-mounted thermostat may resemble thermostats that room guests have in their own homes, which can provide the guests with a more familiar, home-like environment, rather than an impersonal hotel atmosphere. Wall-mounted thermostats, however, usually require additional wiring for conveying communication signals between the thermostat and the PTAC unit and for conveying electrical power to the thermostat.

Such wiring, unfortunately, is often mis-wired and can be prone to electrical noise. If the PTAC system requires two-way communication between the PTAC unit and the remote thermostat, additional wiring may be needed. In some cases, wire impedance can be an issue that limits the wire length. Consequently, a need exists for a simple wiring scheme that overcomes the limitations of current systems.

### SUMMARY OF THE INVENTION

It is an object of the invention to use a single pair of wires for providing electrical power and two-way communication between a remote thermostat and a PTAC or some other type of temperature-conditioning unit.

Another object of some embodiments is use a polarity independent pair of wires (i.e., the wires can be crossed) for providing electrical power and two-way communication between a remote thermostat and a PTAC or some other type of temperature-conditioning unit.

Another object of some embodiments is to selectively operate a PTAC or some other type of temperature conditioning unit in three independent modes: a power mode for conveying electrical power from the PTAC to a remote thermostat, an output mode for transmitting a communication signal from the PTAC to the thermostat, and a feedback mode for receiving a communication signal from the thermostat to the PTAC.

Another object of some embodiments is to provide a remote thermostat with an electrical power storage circuit that powers the thermostat at times when power from a PTAC or other type of temperature-conditioning unit is temporarily interrupted for communication purposes.

Another object of some embodiments is to use a current loop circuit for two-way communication between a remote thermostat and a PTAC or other type of temperature-conditioning unit, wherein the current loop is generally immune to electrical noise and tolerant of wire impedance.

Another object of some embodiments is to avoid conveying substantial electrical power while conveying a communication signal.

Another object of some embodiments is to allow almost any amount and type of data to be sent between a remote thermostat and a PTAC or other type of temperature-conditioning unit.

Another object of some embodiments is to provide a remote thermostat that can display various conditions occurring at a PTAC or other type of temperature-conditioning unit.

One or more of these and/or other objects of the invention are provided by a control system that includes a single pair of polarity independent wires for conveying both electrical power and two-way communication but not at the same time.

The present invention provides a control system. The control system comprises a first controller that includes a first terminal-A and a first terminal-B, and a second controller that includes a second terminal-A and a second terminal-B. The first controller is operable to provide an output signal and receive a feedback signal. The second controller is operable to provide the feedback signal and receive the output signal. The control system also includes a power storage system connected to the second controller, and; a pair of wires that includes a first wire connected to the first terminal-A and a second wire connected to the first terminal-B. The first wire and the second wire are interchangeably connected to the second terminal-A and the second terminal-B. The control system is selectively operable in a power mode, an output mode, and a feedback mode such that:
a) in the power mode, the first controller provides electrical power to the second controller via the pair of wires to store at least some of the electrical power on the power storage system;
b) in the output mode, the power mode and the feedback mode are momentarily inactive so that the first controller can provide the output signal to the second controller via the pair of wires; and
c) in the feedback mode, the power mode and the output mode are momentarily inactive so that the second controller can provide the feedback signal to the first controller via the pair of wires.

The present invention also provides a control system. The control system comprises a temperature-conditioning unit; a thermostat disposed at a remote location relative to the temperature-conditioning unit; a first controller connected to the temperature-conditioning unit; a second controller connected to the thermostat; a power storage system connected to the second controller; and a pair of wires that includes a first wire and a second wire. The first controller includes a first terminal-A and a first terminal-B, and is operable to provide an output signal and receive a feedback signal. The second controller includes a second terminal-A and a second terminal-B, and is operable to provide the feedback signal and receive the output signal. The first wire is connected to the first terminal-A and the second terminal-A, and the second wire is connected to the first terminal-B and the second terminal-B. The control system is selectively operable in a power mode, an output mode, and a feedback mode such that:
a) in the power mode, the first controller provides electrical power to the second controller via the pair of wires to store at least some of the electrical power on the power storage system;
b) in the output mode, the power mode and the feedback mode are momentarily inactive so that the first controller can provide the output signal to the second controller via the pair of wires; and
c) in the feedback mode, the power mode and the output mode are momentarily inactive so that the second controller can provide the feedback signal to the first controller via the pair of wires.

The present invention additionally provides a control system. The control system comprising: a temperature-conditioning unit; a thermostat disposed at a remote location relative to the temperature-conditioning unit; a display disposed on the thermostat, which indicates a condition occurring at the temperature-conditioning unit; a first controller connected to the temperature-conditioning unit; a second controller connected to the thermostat, a power storage system being connected to the second controller and receiving DC electrical power from the first controller; and a pair of wires that includes a first wire and a second wire. The first controller includes a first terminal-A and a first terminal-B, the first controller being operable to provide an output signal and receive a feedback signal, wherein the output signal and the feedback signal are digital. The second controller includes a second terminal-A and a second terminal-B, the second controller being operable to provide the feedback signal and receive the output signal. The first wire is connected to the first terminal-A and the second terminal-A, and the second wire is connected to the first terminal-B and the second terminal-B. The control system is selectively operable in a power mode, an output mode, and a feedback mode such that:
a) in the power mode, the first controller provides electrical power to the second controller via the pair of wires to store at least some of the electrical power on the power storage system;
b) in the output mode, the power mode and the feedback mode are momentarily inactive so that the first controller can provide the output signal to the second controller via the pair of wires; and
c) in the feedback mode, the power mode and the output mode are momentarily inactive so that the second controller can provide the feedback signal to the first controller via the pair of wires.

The present invention further provides a two wire communications link. The two wire communications link comprises an electrical power source; a first controller operably connected to the electrical power source for receiving electrical power therefrom; a second controller; a first electrical connection connecting the first and second controllers and supplying electrical power from the electrical power source to the second controller; and hardware or software, in the first controller, for controlling the connection of the electrical power source to the first electrical connection to create periods of connection, and periods of disconnection, so that a digital communication signal is transmitted over the first electrical connection.

The present invention still further provides a method of digitally communicating over a power line. The method comprises the steps of: providing an electrical power source; electrically connecting a first controller to the electrical power source; providing a second controller; electrically connecting the first controller to the second controller so that power is supplied to the second controller from the electrical power source; controllably connecting the electrical power source to the electrical connection in a manner that creates periods of disconnection and periods of connection; and varying the periods of connection and the period of disconnection so that a digital communication signal is transmitted from the first controller to the second controller.

### BRIEF DESCRIPTION OF THE DRAWINGS

FIG. 1 is a perspective view of a system that includes remote thermostat and a temperature-conditioning unit installed in a room.

FIG. 2 is a wiring schematic of two controllers used in the system of FIG. 1.

FIG. 3 is a chart that explains the operation of the controllers shown in FIG. 2.

### DESCRIPTION OF THE PREFERRED EMBODIMENT

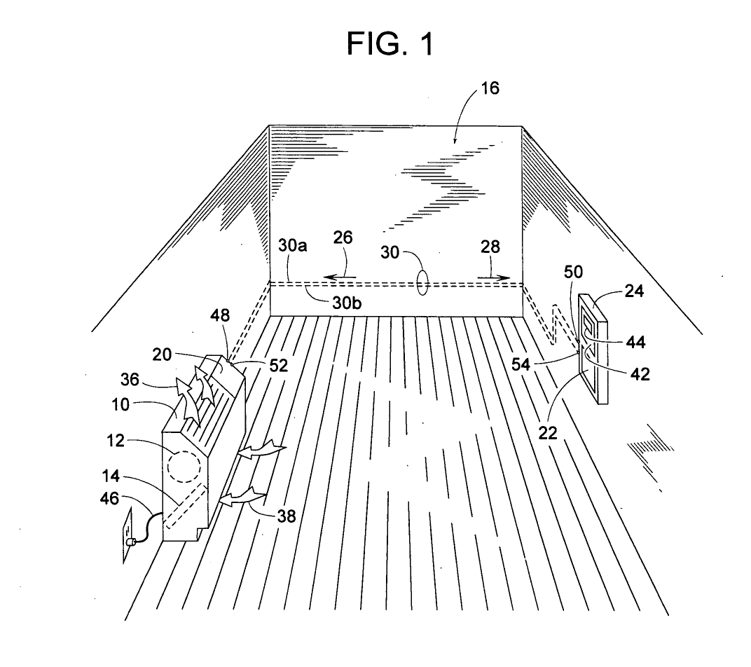

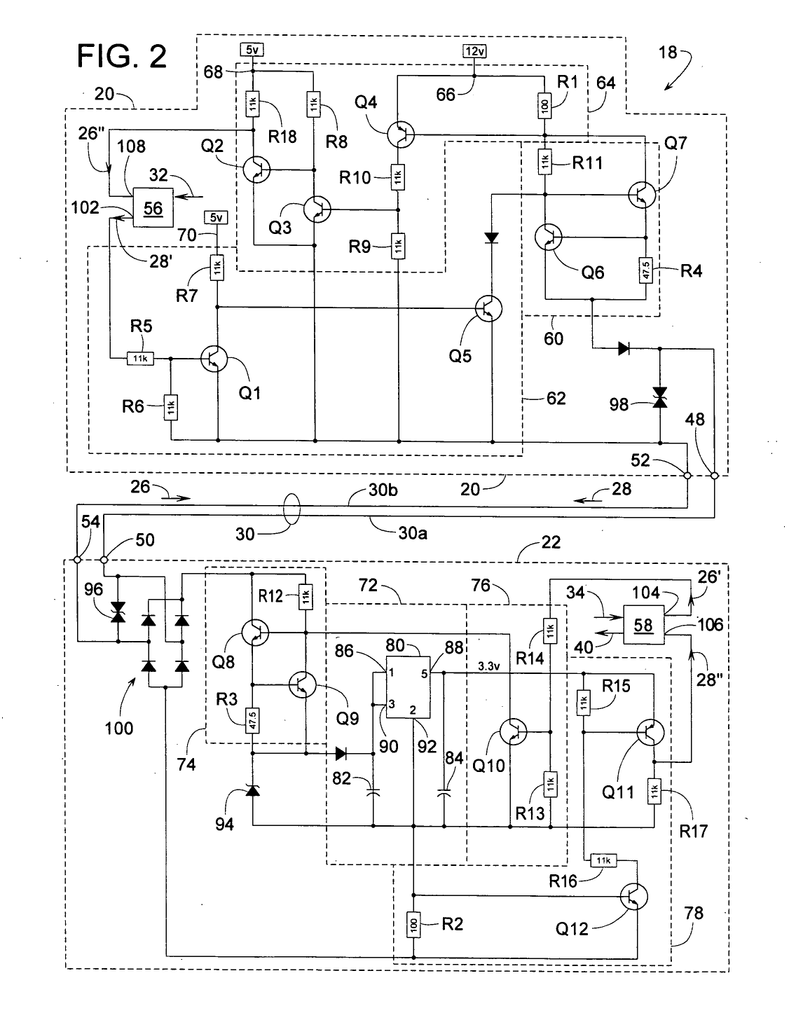

FIG. 1 shows a temperature-conditioning unit 10 (e.g., a PTAC unit) that includes a blower 12 and a heat exchanger 14 for heating, cooling and/or ventilating a comfort zone 16, such as a room or other area in a building. A control system 18, shown in FIG. 2, controls the operation of unit 10. Control system 18 includes a first controller 20 installed in unit 10, and a second controller 22 installed in a remote thermostat 24. A pair of wires 30, comprising a first wire 30a and a second wire 30b, conveys DC electrical power and digital communication signals between controllers 20 and 22.

First controller 20 provides one or more control functions that may include, but are not necessarily limited to, energizing blower 12, energizing a compressor or valves associated with heat exchanger 14, receiving a feedback signal 26 from thermostat 24, transmitting an output signal 28 to thermostat 24, and receiving various input signals 32 from temperature sensors, pressure sensors, manual input switches, etc. that are installed in the general vicinity of unit 10. Feedback signal 26 received from thermostat 24 via wires 30 may include, but is not limited to, temperature set points, room temperature reading, system parameters, and various other inputs 34. Output signal 28 transmitted from controller 20 to thermostat 24 via wires 30 may include, but is not limited to, temperature set points, outdoor air temperature reading, temperature reading of supply air 36, temperature reading of return air 38, system faults and error messages, and system parameters.

Second controller 22 provides one or more control functions that may include, but are not necessarily limited to, receiving output signal 28 from first controller 20, transmitting feedback signal 26 to controller 20, receiving various input signals 34 from temperature sensors, pressure sensors, manual input switches, etc. that are installed in the general vicinity of thermostat 24. Second controller 22 can also provide an output signal 40 that can be used for controlling a visual display 42 on thermostat 24. Display 42 can indicate various conditions occurring at unit 10 and/or thermostat 24. Examples of such conditions include, but are not limited to, the temperature of return air 38, the temperature of supply air 36, a setpoint temperature, a diagnostic message 44 pertaining to unit 10, the room temperature in the vicinity of thermostat 24, setup parameters of unit 10, etc.

A power supply line 46 of the building can supply electrical power to unit 10 and its controller 20. Wires 30 convey some of that electrical power to energize thermostat 24 and its controller 22, thus wires 30 convey both communication and electrical power, but not at the same time.

FIG. 2 shows wire 30a connecting a first terminal-A 48 on first controller 20 to a second terminal-A 50 on second controller 22. Wire 30b is shown connecting a first terminal-B 52 on first controller 20 to a second terminal-B 54 on second controller 22. Wires 30a and 30b, however, can be crossed without creating a problem for the conveyance of communication signals or electrical power. Wire 30a, for instance could be installed to connect first terminal-A 48 to second terminal-B 54, and wire 30b could connect first terminal-A 52 to second terminal-A 50. This feature helps ensure that controllers 20 and 22 are properly connected regardless of how wires 30a and 30b are installed.

To ensure reliable communication between controllers 20 and 22, control system 18 employs a current loop circuit that is inherently noise immune and tolerant of wire impedance. To avoid signal interference, control system 18 selectively operates in three distinct modes: a power mode for conveying electrical power along wires 30, an output mode for conveying output signal 28, and a feedback mode for conveying feedback signal 26. Electrical power, output signal 28 and feedback signal 26 are each conveyed independently of the others. In a currently preferred embodiment, first controller 20 includes a conventional microprocessor 56 that determines which operating mode is in effect, and second controller 22 includes another conventional microprocessor 58 that responds accordingly.

In addition to microprocessor 56, first controller 20 includes a current source circuit 60, a current interrupter 62, and a signal converter 64. A conventional voltage regulator provides 12-VDC at a point 66, and 5-VDC at points 68 and 70. In this particular example, circuit 60 can deliver about 15 mA of current to first terminal-A 48. During the power mode, wires 30 convey that current to power second controller 22. That current is also used for charging an energy storage circuit 72 that powers second controller 22 while the current from circuit 60 is interrupted during the output mode or feedback mode.

In the output mode, current interrupter 62 responds to an output signal 28′ from microprocessor 56 to controllably interrupt the current through wires 30, whereby wires 30 can transmit data (corresponding to output signal 28′) in a standard asynchronous, 19,200-baud method. The “start” and “0” valued bits can be defined as current generally less than 7 mA. The “stop” and “1” valued bits can be defined as current generally greater than 7 mA. Signal converter 64 senses the current level and converts it to standard logic levels.

Second controller 22 includes microprocessor 58, energy storage circuit 72, a current limiter 74, a current interrupter 76, and a signal converter 78. In this example, energy storage circuit 72 includes a conventional voltage regulator 80 operating in conjunction with one or more power storage capacitors 82 and 84 (e.g., 220 uF each). Voltage regulator 80 has a voltage input 86, a regulated DC voltage output 88 (e.g., 3.3 VDC), ON/OFF switch input 90 and a ground 92. If desired, additional capacitors (e.g., 0.1 uF) can be added to drain high frequency noise and voltage transients from point 88 to point 92. As explainer earlier, energy storage circuit 72 is charged during the power mode by at least some of the 15 mA from current source 60, the stored power can then be used for powering second controller 22 (including microprocessor 58) during the output mode and feedback mode.

As wires 30 convey current from controller 20 to controller 22, current limiter 74 and Zener diode 94 help regulate that current at about 15 mA. To guard against voltage spikes, transient voltage suppression diodes 96 and 98 can be installed between wires 30a and 30b. Second controller 22 includes a full wave bridge rectifier 100 that allows the communication and power link between controllers 20 and 22 to be insensitive to the wiring polarity of wires 30.

In response to feedback signal 26′, current interrupter 76 interrupts the current in wires 30 in order to communicate feedback signal 26 to first controller 20. The “start” and “0” valued bits can be defined as current less than 7 mA. The “stop” and “1” valued bits can be defined as current greater than 7 mA.

Signal converter 78 detects the presence and absence of current as a serial data stream and converts it to the logic levels required by the remote thermostat's controller 22.

Although the actual circuit of control system 18 may vary, in a currently preferred embodiment, system 18 includes resistors R1-R18. Resistors R1 and R2 are 100-ohms, resistors R3 and R4 are 47.5-ohms, and resistors R5-R18 are each 11 kilo-ohms.

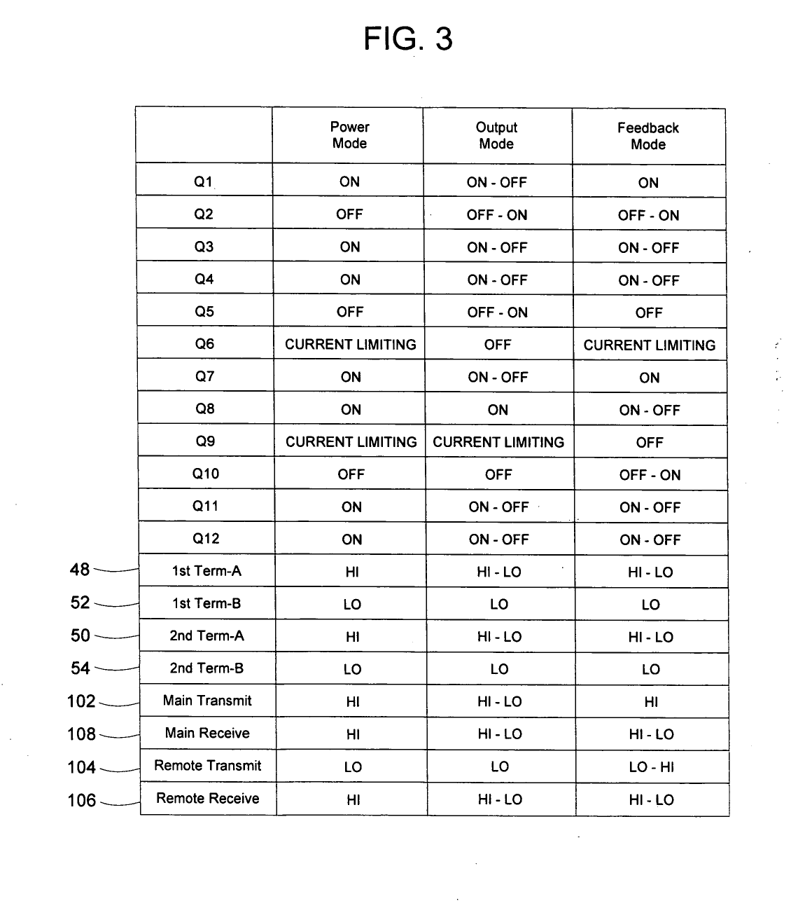

FIG. 3 provides more detail as to what is actually occurring with individual elements of control system 18 selectively operating in the power mode, output mode and feedback mode. With the exception of transistors Q6 and Q9, which are used for limiting the current to 15 mA, the other transistors Q1-Q5, Q7, Q8, and Q10-Q12 are used as switching transistors generally operating in a binary ON/OFF state. In the chart of FIG. 3, “ON-OFF” indicates a transistor that changes from being on (saturated) to off with every pulse of signal 26′ or 28′, and “OFF-ON” indicates a transistor that changes from being off to on with every pulse of signal 26′ or 28′. In that same chart, “HI” and “LO” represent relative high and low voltage, respectively. “HI-LO” indicates a voltage drop with every pulse of signal 26′ or 28′, and “LO-HI” indicates an increase in voltage with every pulse of signal 26′ or 28′.

In the power mode, microprocessor 56 does not provide any pulsed signal at a main transmit point 102, and microprocessor 58 does not provide any pulsed signal at a remote transmit point 104, thus a remote receive point 106 and a main receive point 108 remain at a generally constant level of “HI,” whereby generally no communication occurs between controllers 20 and 22. In the power mode, first terminal-A 48 remains relatively “HI” to charge energy storage circuit 72.

In the output mode, output signal 28′ is communicated from main transmit point 102 of microprocessor 56 to remote receive point 106 on microprocessor 58. At point 106, output signal 28′ is read as output signal 28″. In the output mode, the chart of FIG. 3 shows that remote receive point 106 goes from “HI” to “LO” with every “HI-LO” pulse of main transmit point 102. The pulsed information of output signal 28, 28′ or 28″ can represent temperature set points, outdoor air temperature reading, temperature reading of supply air 36, temperature reading of return air 38, system faults and error messages, and system parameters. The pulsed information of output signal 28, 28′ or 28″ can also be a means for providing second microprocessor 58 with permission to transmit feedback signal 26′.

In the feedback mode, feedback signal 26′ is communicated from remote transmit point 104 of microprocessor 58 to main receive point 108 on microprocessor 56. At point 108, feedback signal 26′ is read as feedback signal 26″. In the feedback mode, the chart of FIG. 3 shows that main receive point 108 goes from “HI” to “LO” with every “LO-HI” pulse of remote transmit point 104. Although pulses 26′ and 26″ are 180-degrees out of phase, the feedback information is conveyed nonetheless. In some embodiments, the electrical power conveyed by wires 30 has a DC voltage amplitude that is substantially equal to that of communication signals 26 and 28.

Although the invention is described with respect to a preferred embodiment, modifications thereto will be apparent to those of ordinary skill in the art. Control system 18, for instance, does not necessarily have to be used for controlling a PTAC unit, but could be applied to any type of HVAC equipment. Therefore, the scope of the invention is to be determined by reference to the following claims.

1. A control system, comprising:
a first controller that includes a first terminal-A and a first terminal-B, the first controller being operable to provide an output signal and receive a feedback signal;
a second controller that includes a second terminal-A and a second terminal-B, the second controller being operable to provide the feedback signal and receive the output signal;
a power storage system connected to the second controller;
a pair of wires that includes a first wire connected to the first terminal-A and a second wire connected to the first terminal-B, the first wire and the second wire are interchangeably connected to the second terminal-A and the second terminal-B, the control system is selectively operable in a power mode, an output mode, and a feedback mode such that:
d) in the power mode, the first controller provides electrical power to the second controller via the pair of wires to store at least some of the electrical power on the power storage system;
e) in the output mode, the power mode and the feedback mode are momentarily inactive so that the first controller can provide the output signal to the second controller via the pair of wires; and
f) in the feedback mode, the power mode and the output mode are momentarily inactive so that the second controller can provide the feedback signal to the first controller via the pair of wires.

2. The control system of claim 1, further comprising a temperature-conditioning unit, and the first controller is connected to the temperature-conditioning unit.

3. The control system of claim 2, further comprising a thermostat disposed at a remote location relative to the temperature-conditioning unit, wherein the second controller is connected to the thermostat, and the pair of wires extend between the thermostat and the temperature-conditioning unit.

4. The control system of claim 3, wherein the thermostat disposed at a remote location includes a display that indicates a condition occurring at the temperature-conditioning unit.

5. The control system of claim 4, wherein the condition is a temperature near the temperature-conditioning unit.

6. The control system of claim 4, wherein the display provides a diagnostic message pertaining to the condition occurring at the temperature-conditioning unit.

7. The control system of claim 1, wherein the output signal and the feedback signal are digital.

8. The control system of claim 1, wherein the electrical power has a voltage amplitude substantially equal to that of the output signal and the feedback signal.

9. The control system of claim 1, wherein the first controller determines whether the control system is operating in the power mode, output mode, or feedback mode.

10. A control system, comprising:
a temperature-conditioning unit;
a thermostat disposed at a remote location relative to the temperature-conditioning unit;
a first controller connected to the temperature-conditioning unit, the first controller includes a first terminal-A and a first terminal-B, the first controller being operable to provide an output signal and receive a feedback signal;
a second controller connected to the thermostat, the second controller includes a second terminal-A and a second terminal-B, the second controller being operable to provide the feedback signal and receive the output signal;
a power storage system connected to the second controller;
a pair of wires that includes a first wire and a second wire, the first wire is connected to the first terminal-A and the second terminal-A, and the second wire is connected to the first terminal-B and the second terminal-B, the control system is selectively operable in a power mode, an output mode, and a feedback mode such that:
d) in the power mode, the first controller provides electrical power to the second controller via the pair of wires to store at least some of the electrical power on the power storage system;
e) in the output mode, the power mode and the feedback mode are momentarily inactive so that the first controller can provide the output signal to the second controller via the pair of wires; and
f) in the feedback mode, the power mode and the output mode are momentarily inactive so that the second controller can provide the feedback signal to the first controller via the pair of wires.

11. The control system of claim 10, wherein the thermostat disposed at a remote location includes a display that indicates a condition occurring at the temperature-conditioning unit.

12. The control system of claim 11, wherein the condition is a temperature near the temperature-conditioning unit.

13. The control system of claim 11, wherein the display provides a diagnostic message pertaining to the condition occurring at the temperature-conditioning unit.

14. The control system of claim 10, wherein the output signal and the feedback signal are digital.

15. The control system of claim 10, wherein the electrical power has a voltage amplitude substantially equal to that of the output signal and the feedback signal.

16. The control system of claim 10, wherein the first controller determines whether the control system is operating in the power mode, output mode, or feedback mode.

17. A control system, comprising:
a temperature-conditioning unit;
a thermostat disposed at a remote location relative to the temperature-conditioning unit;
a display disposed on the thermostat, wherein the display indicates a condition occurring at the temperature-conditioning unit;
a first controller connected to the temperature-conditioning unit, the first controller includes a first terminal-A and a first terminal-B, the first controller being operable to provide an output signal and receive a feedback signal, wherein the output signal and the feedback signal are digital;
a second controller connected to the thermostat, the second controller includes a second terminal-A and a second terminal-B, the second controller being operable to provide the feedback signal and receive the output signal;
a power storage system being connected to the second controller and receiving DC electrical power from the first controller;
a pair of wires that includes a first wire and a second wire, the first wire is connected to the first terminal-A and the second terminal-A, and the second wire is connected to the first terminal-B and the second terminal-B, the control system is selectively operable in a power mode, an output mode, and a feedback mode such that:
d) in the power mode, the first controller provides electrical power to the second controller via the pair of wires to store at least some of the electrical power on the power storage system;
e) in the output mode, the power mode and the feedback mode are momentarily inactive so that the first controller can provide the output signal to the second controller via the pair of wires; and
f) in the feedback mode, the power mode and the output mode are momentarily inactive so that the second controller can provide the feedback signal to the first controller via the pair of wires.

18. The control system of claim 17, wherein the condition is a temperature near the temperature-conditioning unit.

19. The control system of claim 17, wherein the display provides a diagnostic message pertaining to the condition occurring at the temperature-conditioning unit.

20. The control system of claim 17, wherein the first controller determines whether the control system is operating in the power mode, output mode, or feedback mode.

21. A two wire communications link comprising:
an electrical power source;
a first controller operably connected to the electrical power source for receiving electrical power therefrom;
a second controller;
first electrical connection connecting the first and second controllers and supplying electrical power from the electrical power source to the second controller; and
means, in the first controller, for controlling the connection of the electrical power source to the first electrical connection to create periods of connection, and periods of disconnection, so that a digital communication signal is transmitted over the first electrical connection.

22. The link of claim 21 further including means, in the second controller, for storing power during periods of connection and means, in the second controller, for using stored power during periods of disconnection.

23. A method of digitally communicating over a power line comprising the steps of:
providing an electrical power source;
electrically connecting a first controller to the electrical power source;
providing a second controller;
electrically connecting the first controller to the second controller so that power is supplied to the second controller from the electrical power source;
controllably connecting the electrical power source to the electrical connection in a manner that creates periods of disconnection and periods of connection; and
varying the periods of connection and the period of disconnection so that a digital communication signal is transmitted from the first controller to the second controller.

24. The method of claim 23 including the further step of storing power in the second controller during periods of connection for use during periods of disconnection.
